(19) United States
(12) Patent Application Publication
(10) Pub. No.: US 2016/0163025 A1
(43) Pub. Date: Jun. 9, 2016

(54) DISPLAY DEVICE AND A METHOD OF DRIVING THE SAME

(71) Applicant: SAMSUNG DISPLAY CO., LTD., Yongin-si (KR)

(72) Inventors: MASAYUKI KUMETA, Yokohama (JP); Ryo Ishii, Yokohama (JP)

(21) Appl. No.: 14/870,997

(22) Filed: Sep. 30, 2015

(30) Foreign Application Priority Data
Dec. 3, 2014 (JP) 2014-245313

(51) Int. Cl. G06T 5/00; G09G 3/20

(52) U.S. Cl. CPC G06T 5/001; G09G 3/2003; G09G 2320/02

(57) ABSTRACT

A display device includes pixel circuits, data lines, and data selection switches. The data lines includes first and second group of data lines. Each of the first group of data lines is connected to one of the pixel circuits in a first column (or row) of the pixel circuits. Each of the second group of data lines is connected to one of the pixels in a second column (or row) of the pixel circuits. Each of the data selection switches connects one of the first group of data lines and one of driver output ports in response to a switching control signal. The first group of data lines includes a first data line connected to a first pixel circuit of the pixel circuits and a second data line connected to a second pixel circuit adjacent to the first pixel circuit.

### CROSS-REFERENCE TO RELATED APPLICATION

This U.S. non-provisional patent application claims priority under 35 U.S.C. §119 to Japanese Patent Application No. JP2014-245313, filed on Dec. 3, 2014, in the Japanese Intellectual Property Office, the disclosure of which is incorporated by reference herein in its entirety.

### TECHNICAL FIELD

The present inventive concept relates to a display device and a method of driving the same.

### DISCUSSION OF THE RELATED ART

As the resolution of display device increases, a horizontal period for data writing decreases, and thus, an image quality can be deteriorated.

### SUMMARY

According to an exemplary embodiment of the present inventive concept, a display device is provided. The display device includes a plurality of pixel circuits, a plurality of data lines, and a plurality of data selection switches. The plurality of pixel circuits is disposed in a matrix. The plurality of data lines includes a first group of data lines and a second group data lines. Each of the first group of data lines is connected to at least one of the pixel circuits in a first column or a first row of the plurality of pixel circuits. Each of the second group of data lines is connected to at least one of the pixel circuits in a second column or a second row of the plurality of pixel circuits. Each of the plurality of data selection switches connects one of the first group of data lines and one of a plurality of driver output ports in response to a switching control signal. Each of the plurality of driver output ports outputs data corresponding to one of colors of light emitted through the plurality of pixel circuits. The data corresponding to one of the colors of light emitted through the plurality of pixel circuits is supplied to at last one data line of the first group of data lines. The first group of data lines includes a first data line and a second data line. The first data line is connected to a first pixel circuit of the plurality of pixel circuits. The second data line is connected to a second pixel circuit of the plurality of pixel circuits. The second pixel circuit is adjacent to the first pixel circuit. The first and second data lines are different from each other. A data update period for updating data written to at least a third pixel circuit of the plurality of pixel circuits includes a data line write period for writing data to a third data line of the plurality of data lines and a pixel circuit write period for writing data to the third pixel circuit. The pixel circuit write period occurs after the data line write period.

In an exemplary embodiment of the present inventive concept, the data update period may include a plurality of horizontal periods. The data line write period may correspond to some of the plurality of horizontal periods. The pixel circuit write period may correspond to horizontal periods excluding those corresponding to the data line write period among the plurality of horizontal periods.

In an exemplary embodiment of the present inventive concept, a plurality of data writes may be performed within a first horizontal period in the data line write period or the pixel circuit write period. An order of writing data to a first pixel circuit during the first horizontal period may be different from an order of writing data to a second pixel circuit adjacent to the first pixel circuit.

In an exemplary embodiment of the present inventive concept, a first data selection switch of the plurality of data selection switches may connect a first data line and a first driver output port of the plurality of driver output ports in a first horizontal period. A second data selection switch of the plurality of data selection switches may connect the second data line and a second driver port of the plurality of driver output ports in a second horizontal period different from the first horizontal period.

In an exemplary embodiment of the present inventive concept, the display device may further include a driver having the plurality of driver output ports.

In an exemplary embodiment of the present inventive concept, the display device may further include a driver outputting the switching control signal.

In an exemplary embodiment of the present inventive concept, each of the first group of data lines may be disposed in a region adjacent to the first column or the first row of the plurality of pixel circuits.

In an exemplary embodiment of the present inventive concept, the first data line may be disposed in a first side of the first column or the first row. The second data line may be disposed in a second side of the first column or the first row. The second side may be an opposite side to the first side.

According to an exemplary embodiment of the present inventive concept, a driving method of a display device is provided. The driving method includes updating data written to each pixel circuit of a plurality of pixel circuits. Updating the data includes writing first data of the data to a first data line of a plurality of data lines in the display device during a first period and writing the first data to a first pixel circuit of the plurality of pixel circuits during a second period subsequent to the first period The display device includes the plurality of pixel circuits, the plurality of data lines, and a plurality of data selection switches. The plurality of data lines includes a first group of data lines and a second group data lines. Each of the first group of data lines is connected to at least one of the pixel circuits in a first column or a first row of the plurality of pixel circuits. Each of the second group of data lines is connected to at least one of the pixel circuits in a second column or a second row of the plurality of pixel circuits. Each of the plurality of data selection switches connects one of the first group of data lines and one of a plurality of driver output ports in response to a switching control signal. Each of the plurality of driver output ports outputs the data corresponding to one of colors of light emitted through the plurality of pixel circuits. The data corresponding to one of the colors of light emitted through the plurality of pixel circuits is supplied to each data line of the first group of data lines. The first group of data lines includes a first data line and a second data line. The first data line is connected to a first pixel circuit of the plurality of pixel circuits. The second data line is connected to a second pixel circuit of the plurality of pixel circuits. The second pixel circuit is adjacent to the first pixel circuit.

In an exemplary embodiment of the present inventive concept, the driving method may further include writing second data of the data to the second data line during the second period and writing the second data to the second pixel circuit during a third period subsequent to the second period.

According to an exemplary embodiment of the present inventive concept, a display device is provided. The display device includes a plurality of pixel circuits, a plurality of data lines, and a plurality of switches. The plurality of data lines includes a first group of data lines and a second group data lines. Each of the first group of data lines is connected to at least one of the pixel circuits in a first column or a first row of the plurality of pixel circuits. Each of the second group of data lines is connected to at least one of the pixel circuits in a second column or a second row of the plurality of pixel circuits. Each of the plurality of switches controls a connection between one of the first group of data lines and one of a plurality of driver output ports in response to a switching control signal. Each of the plurality of driver output ports outputs the switching control signal and first data to at least one data line of the first group of data lines through at least one of the plurality of switches. The first group of data lines includes a first data line and a second data line. The first data line is connected to a first pixel circuit of the plurality of pixel circuits. The second data line is connected to a second pixel circuit of the plurality of pixel circuits. The second pixel circuit is adjacent to the first pixel circuit.

In an exemplary embodiment of the present inventive concept, the first data may correspond to one of colors of light emitted through the plurality of pixel circuits.

In an exemplary embodiment of the present inventive concept, the colors of light emitted through the plurality of pixel circuits may include a red color, a green color, or a blue color.

In an exemplary embodiment of the present inventive concept, a data update period for updating data written to at least a third pixel circuit of the plurality of pixel circuits may include a data line write period for writing data to a third data line of the plurality of data lines and a pixel circuit write period for writing data to the third pixel circuit. The pixel circuit write period may be subsequent to the data line write period.

In an exemplary embodiment of the present inventive concept, the data update period may include a plurality of horizontal periods. The data line write period may correspond to some of the plurality of horizontal periods. The pixel circuit write period may correspond to horizontal periods excluding those corresponding to the data line write period among the plurality of horizontal periods.

### BRIEF DESCRIPTION OF THE FIGURES

Exemplary embodiments of the present inventive concept will be more clearly understood from the following detailed description taken in conjunction with the accompanied drawings in which:

FIG. 1 is a view illustrating a configuration of a display device according to an exemplary embodiment of the present inventive concept;

FIG. 2 is a timing chart illustrating an operation of a display device according to an exemplary embodiment of the present inventive concept;

FIG. 3 is a view illustrating a configuration of a pixel circuit in a display device according to an exemplary embodiment of the present inventive concept;

FIG. 4A is a view illustrating a data update operation of a display device according to an exemplary embodiment of the present inventive concept;

FIG. 4B is a view illustrating a data update operation of a display device according to an exemplary embodiment of the present inventive concept;

FIG. 4C is a view illustrating a data update operation of a display device according to an exemplary embodiment of the present inventive concept;

FIG. 5 is a view illustrating a configuration of a display device according to an exemplary embodiment of the present inventive concept;

FIG. 6 is a timing chart illustrating an operation of a display device according to an exemplary embodiment of the present inventive concept;

FIG. 7 is a view illustrating a configuration of a display device according to an exemplary embodiment of the present inventive concept;

FIG. 8 is a timing chart illustrating an operation of a display device according to an exemplary embodiment of the present inventive concept;

FIG. 9 is a view illustrating a configuration of a display device according to an exemplary embodiment of the present inventive concept; and

FIG. 10 is a timing chart illustrating an operation of a display device according to an exemplary embodiment of the present inventive concept.

### DETAILED DESCRIPTION OF THE EMBODIMENTS

Hereinafter, exemplary embodiments of the present inventive concept will be described in more detail with reference to the accompanying drawings. The present inventive concept, however, may be embodied in various forms and shall not be construed as being limited to only the limited embodiments. Like reference numbers may refer to like elements throughout the specification and drawings.

Additionally, in this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.).

A display device according to an exemplary embodiment of the present inventive concept may be an active matrix type display device in which a plurality of pixel circuits are disposed in a matrix form.

The display device according to an exemplary embodiment of the present inventive concept may be a display device with a pixel circuit including a light emitting device, which emits light when current flows, and a driving transistor, or may be a display device with a pixel circuit including a liquid crystal device and a driving transistor.

A light emitting device according to an exemplary embodiment of the present inventive concept may be a light emitting device (e.g., an organic electro luminescence (EL) element or an inorganic electro luminescence element) which emits light when current flows.

Hereinafter, as an example, it is assumed that the display device according to an exemplary embodiment of the present inventive concept is a display device with a pixel circuit including a light emitting device and a driving transistor, and the light emitting device according to an exemplary embodiment of the present inventive concept is an organic electro luminescence device.

In addition, the display device according to an exemplary embodiment of the present inventive concept is driven under control by a driver, which is included in the display device, or an external driver of the display device.

The display device according to an exemplary embodiment of the present inventive concept further includes two configurations as shown in (a) and (b) below, in addition to the plurality of pixel circuits disposed in a matrix.

(a) A Group of Data Lines Corresponding to Each Column (or Row) of a Plurality of Pixel Circuits

The display device according to an exemplary embodiment of the present inventive concept may include a plurality of data lines. The plurality of data lines may include a plurality of groups of data lines. In a plurality of pixel circuits disposed in a matrix, each group of data lines is disposed to correspond to each column (or row) of a plurality of pixel circuits. Each group of data lines may include first through n-th data lines DT1(x) through DTn(x). Here, n is an integer greater than one, and corresponds to the number of data lines in a group of data lines, x is an integer equal to or greater than zero, and corresponds to a column number of the plurality of pixel circuits. For example, the group of data lines DT1(x) through DTn(x) may be disposed in a region around a corresponding column (or row) (e.g., an x-th column (or row)) of the plurality of pixel circuits. In an exemplary embodiment of the present inventive concept, the number of the plurality of data lines in the display device according to an exemplary embodiment of the present inventive concept may be n times (e.g., n is an integer of 2 or more) of the number of columns (or rows) in the pixel circuit matrix.

(b) A Plurality of Data Selection Switches Corresponding to Each Column (or Row) of a Plurality of Pixel Circuits

Each data selection switch is connected between one of the plurality of data lines and one of the plurality of driver outputs, each of which supplies data corresponding to a predetermined color. For example, each data selection switch selectively connects one of the data lines and one of the driver outputs on the basis of a switching control signal.

For example, the data selection switch according to an exemplary embodiment of the present inventive concept may be a transistor that is turned on or turned off on the basis of a switching control signal applied to a gate of the transistor. The transistor according to an exemplary embodiment of the present inventive concept may be a thin film transistor (TFT) or a field-effect transistor (FET) such as a metal-oxide-semiconductor field effect transistor (MOSFET), or the like. A conductive type of the transistor according to an exemplary embodiment of the present inventive concept may be a P channel type or an N channel type.

In addition, a data selection switch according to an exemplary embodiment of the present inventive concept is not limited to the transistor. For example, a data selection switch according to an exemplary embodiment of the present inventive concept may be an arbitrary circuit device (or a circuit) having substantially the same function as the transistor.

In addition, data (e.g., data supplied by a driver to a data line) corresponding to a predetermined color according to an exemplary embodiment of the present inventive concept, may be data representing each of three primary colors of light. However, data corresponding to a predetermined color according to an exemplary embodiment of the present inventive concept is not limited to the data representing each of the three primary colors of light. For example, the data corresponding to a predetermined color may be data representing a white color, or the like.

In an exemplary embodiment of the present inventive concept, a driver (e.g., a data driver, or an internal driver) having the plurality of driver outputs may be included in the display device. In an exemplary embodiment of the present inventive concept, the driver may be an external driver, for example, which is positioned outside of the display device.

In an exemplary embodiment of the present inventive concept, the switching control signal is outputted from a driver (e.g., an internal driver) included in the display device or an external driver of the display device. In an exemplary embodiment of the present inventive concept, the switching control signal may be outputted from the driver having the plurality of driver outputs. In an exemplary embodiment of the present inventive concept, the switching control signal may be outputted from a driver other than the driver having the plurality of driver outputs. A detailed example of a switching control signal according to an exemplary embodiment of the present inventive concept is described later.

In addition, the display device according to an exemplary embodiment of the present inventive concept has a connection relationship among a data line, a data selection switch, and a driver output, which satisfy the following features (c) and (d) as shown below.

(c) Data corresponding to a color (e.g., a predetermined color) is supplied to each of the plurality of data lines. Each group of data lines of the plurality of data lines is disposed to correspond to each column (or row) of the plurality of pixel circuits. For example, a color represented by data supplied to each data line of a group of data lines (e.g., DT1(x) through DTn(x)) disposed to correspond to each column (or row) (e.g., an x-th column (or row)) of the plurality of pixel circuits is fixed (e.g., not changed).

(d) In a plurality of pixel circuits disposed in a matrix, a data line (e.g., DTi(x)) connected to a first pixel circuit is different from a data line (e.g., DTj(x)) connected to a second pixel circuit which is adjacent to the first pixel circuit in a row or column direction. Here, i and j are integers equal to or greater than one and equal to or smaller than n).

In an exemplary embodiment of the present inventive concept, the display device may have a configurations described in (a) and (b) and a connection relationship described in (c) and (d).

In an exemplary embodiment of the present inventive concept, the display device is driven such that a data update period for updating data written to a pixel circuit is divided into a data line write period for writing data to a data line and a pixel circuit write period for writing data to a pixel circuit. Hereinafter, this driving scheme for the display device is referred to as “(e)”. Here, the pixel circuit write period may be subsequent to a data line write period.

In an exemplary embodiment of the present inventive concept, a data update period may be a plurality of horizontal periods. A data line write period included in the data update period corresponds to at least one of the plurality of horizontal periods, and a pixel circuit write period included in the data update period corresponds to horizontal periods other than the data line write period among the plurality of horizontal periods.

The driving of the display device according to an exemplary embodiment of the present inventive concept according to the scheme (e) is performed by turning on or turning off each data selection switch on the basis of a switching control signal or by operating a pixel circuit on the basis of various control signals CLRS supplied to the pixel circuit.

In an exemplary embodiment of the present inventive concept, the various control signals CLRS supplied to the pixel circuit are outputted from a driver (e.g., an internal driver) included in the display device or an external driver of the display device. In addition, in an exemplary embodiment of the present inventive concept, the various control signals CLRS may be outputted from the driver outputting the switching control signal. In an exemplary embodiment of the present inventive concept, the various control signals CLRS may be outputted from the driver having the plurality of driver outputs. In an exemplary embodiment of the present inventive concept, the various control signals CLRS may be outputted from a driver other than from the driver having the plurality of driver outputs and the driver having the plurality of driver outputs. The various control signals CLRS according to an exemplary embodiment of the present inventive concept will be described in more detail later.

In an exemplary embodiment of the present inventive concept, the display device includes a plurality of pixel circuits disposed in a matrix and further includes a configuration described in (a) and (b) and a connection relationship described in (c) and (d), and the display device is driven as described in (e).

In the display device according to an exemplary embodiment of the present inventive concept, each group of data lines (e.g., DT1(x) through DTn(x)) of a plurality of data lines is disposed to correspond to each column (or row) (e.g., an x-th column (or row)) of a plurality of pixel circuits disposed in a matrix, a data update period includes a data line write period and a pixel circuit write period, and data update is performed in a plurality of horizontal periods. Accordingly, the display device according to an exemplary embodiment of the present inventive concept may extend a data update period.

In addition, in the display device according to an exemplary embodiment of the present inventive concept, data corresponding to a fixed color (e.g., a predetermined color) is supplied to each of the plurality of data lines, each group of data lines of which is disposed to correspond to each column (or row) (e.g., an x-th column (or row)) of the plurality of pixel circuits, and a data line (e.g., DTi(x)) connected to a first pixel circuit is different from a data line (e.g., DTj(x)) connected to a second pixel circuit which is adjacent to the first pixel circuit in a row or column direction. For example, a color represented by data supplied to each data line of a group of data lines (e.g., DT1(x) through DTn(x)) disposed to correspond to each column (or row) (e.g., an x-th column (or row)) of the plurality of pixel circuits is fixed (e.g., not changed).

Accordingly, in the display device according to an exemplary embodiment of the present inventive concept, image quality deterioration (e.g., line defects) occurring due to a data line variation is reduced.

Accordingly, a display device driven through a driving method according to an exemplary embodiment of the present inventive concept may reduce image quality deterioration caused from the lack of data write and a variation in a plurality of data lines. Thus, the display device according to an exemplary embodiment of the present inventive concept may achieve both high resolution and high image quality.

Hereinafter, a display device according to an exemplary embodiment of the present inventive concept and a method of driving the display device will be described in more detail. Hereinafter, for purpose of illustration, a configuration in which each group of data lines (e.g., DT1(x) through DTn(x)) is disposed to correspond to each column (e.g., an x-th column (or row)) of a plurality of pixel circuits disposed in a matrix is described. However, the present inventive concept is not limited thereto. The group of data lines (e.g., DT1(x) through DTn(x)) may be disposed at each row (e.g., an x-th row) of a plurality of pixel circuits disposed in a matrix.

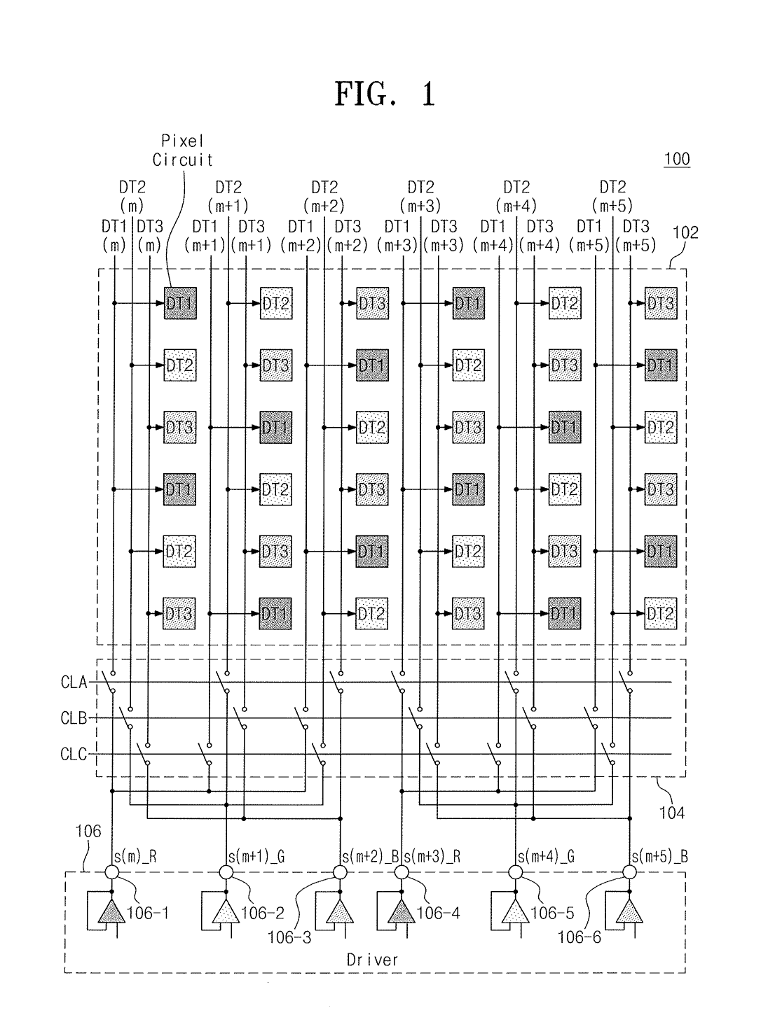

FIG. 1 is a view illustrating a configuration of a display device 100 according to an exemplary embodiment of the present inventive concept.

The display device 100 shown in FIG. 1 includes, for example, a display unit 102, a switching unit 104, and a driver 106.

The display unit 102 includes a plurality of pixel circuits disposed in a matrix and displays an image based on data supplied through a plurality of data lines, on a display screen. As shown in FIG. 1, 6×6 pixel circuits (e.g., the number of pixel circuits in a row direction is six and the number of pixel circuits in a column direction is six) are disposed in a matrix. The number of pixel circuits included in the display device 100 is not limited to the description with reference to FIG. 1. For example, the display device 100 includes a plurality of pixel circuits, the number of which corresponds to a display resolution.

A configuration of a pixel circuit according to an exemplary embodiment of the present inventive concept will be described later.

In the display device 100, each group of data lines including three data lines DT1(x), DT2(x), and DT3(x) (e.g., when n is three) is disposed to correspond to each column (e.g., an x-th column) of the plurality of pixel circuits. Here, x corresponds to a column number of a pixel circuit to which the three data lines DT1(x), DT2(x), and DT3(x) corresponds. Referring to FIG. 1, six columns of the plurality of pixel circuits of the display device 100 are illustrated as an example. In this case, the number of data lines in the display device 100 may be 18. However, the number of data lines of the present inventive concept is not limited thereto. While FIG. 1 illustrates that three data lines (e.g., DT1(x) through DT3(x)) are disposed to correspond to each column (e.g., an x-th column) of the plurality of pixel circuits, the number of data lines disposed to correspond to each column of the plurality of pixel circuits of the present inventive concept is not limited thereto.

Referring to FIG. 1, each of first pixel circuits arranged in a certain same column among a plurality of pixel circuits disposed in a matrix is connected to one of the data lines DT1(x), DT2(x), and DT3(x). For example, the data lines DT1(x), DT2(x), and DT3(x) are disposed to correspond to the same column to which the first pixel circuits belong. For example, a data line (e.g., DTi(x)) connected to a pixel circuit arranged in a first column is different from a data line (e.g., DTj(x+1)) connected to a pixel circuit arranged in a second column (e.g., a column adjacent to the first column).

As shown in FIG. 1, a type of a data line (e.g., one data line belongs to a certain group of data lines) connected a first pixel circuit is different from a type of a data line (e.g., another data line belongs to the certain group of data lines) connected to a second pixel circuit which is adjacent to the first pixel circuit in the same column. According to an exemplary embodiment of the present inventive concept, a type of a data line of a group of data lines corresponding to a column of the plurality of pixel circuits may be understood to be classified by how far the data line is positioned from a reference data line of the group of data lines. For example, as shown in FIG. 1, three types of data lines exist. For example, in the display device 100 shown in FIG. 1, a connection relationship between the data lines DT1(x), DT2(x), and DT3(x) and pixel circuits which are adjacently disposed in the same column is as follows.
a pixel circuit adjacent to a pixel circuit connected to the data line DT1(x) is connected to the data line DT2(x) or the data line DT3(x).
a pixel circuit adjacent to a pixel circuit connected to the data line DT2(x) is connected to the data line DT1(x) or the data line DT3(x).
a pixel circuit adjacent to a pixel circuit connected to the data line DT3(x) is connected to the data line DT1(x) or the data line DT2(x).

Accordingly, in the display device 100, a data line (e.g., DTi(x)) connected to a first pixel circuit is different from a data line (e.g., DTj(x)) connected to a second pixel circuit which is adjacent to the first pixel circuit in a row or column direction.

For example, in the display device 100, at least one signal line to which various control signals CLRS are supplied is disposed to correspond to each row of the plurality of pixel circuits in the display device 100. The signal line to which various control signals CLRS are supplied will be described with description with a configuration a pixel circuit to be described later.

The switching unit 104 includes a plurality of data selection switches corresponding to each data line (e.g., DTk(x)). Here, k is an integer equal to or greater than one and equal to or smaller than n.

Each data selection switch is connected to one of a plurality of data lines and one of a plurality of driver outputs. The driver 106 includes the plurality of driver outputs 106-1 through 106-6. When each data selection switch is turned on or turned off on the basis of a switching control signal, a corresponding data line is selectively connected to a corresponding driver output (e.g., one of 106-1 through 106-6).

Each driver output (e.g., each of 106-1 through 106-6) of the driver 106 outputs, for example, data amplified by an amplifier. As shown in FIG. 1, for example, the driver 106 includes six driver outputs 106-1 through 106-6. The six driver outputs 106-1 through 106-6 include two driver outputs (e.g., 106-1 and 106-4) which output data s(m)_R and S(m+3)_R, respectively, each of the two driver outputs corresponds to a red color, two driver outputs (e.g., 106-2 and 106-5) which output data s(m+1)_G and S(m+4)_G, respectively, each of which corresponds to a green color of light, and two driver outputs (e.g., 106-3 and 106-6) which output data s(m+2)_B and S(m+5)_B, respectively, each of which corresponds to a blue color of light.

As shown in FIG. 1, each of the driver outputs (e.g., 106-1 and 106-4) which outputs the data s(m)_R and S(m+3)_R, respectively, is connected to the data line DT1(x) through at least one data selection switch, each of the driver outputs (e.g., 106-2 and 106-5) which output the data s(m+1)_G and S(m+4)_G, respectively, is connected to the data line DT2(x) through at least one data selection switch, and each of the driver outputs (e.g., 106-3 and 106-6) which output the data s(m+2)_B and S(m+5)_B, respectively, is connected to the data line DT3(x) through at least one data selection switch. For example, in the display device 100, data corresponding to a fixed color (e.g., a predetermined color, or one of colors of light emitted through the plurality of pixel circuits) is supplied to each of a group of data lines (e.g., DT1(x) through DT3(x)) disposed to correspond to each column (e.g., an x-th column) of the plurality of pixel circuit disposed in a matrix. For example, a color represented by data supplied to each data line of the group of data lines (e.g., DT1(x) through DT3(x)) is fixed (e.g., not changed).

As described above, a data line (e.g., DTi(x)) connected to a first pixel circuit is different from a data line (e.g., DTj(x)) connected to a second pixel circuit which is adjacent to the first pixel circuit in a row or column direction. Accordingly, in a data update period, data corresponding to a fixed color (e.g., one of colors of light emitted through the plurality of pixel circuits) is written (e.g., provided) to a first pixel circuit through a first data line (e.g., DTi(x)), and data corresponding to a color is written to a second pixel circuit through a second data line (e.g., DTj(x)). The second pixel circuit is adjacent to the first pixel circuit in a row direction or a column direction in the display device 100.

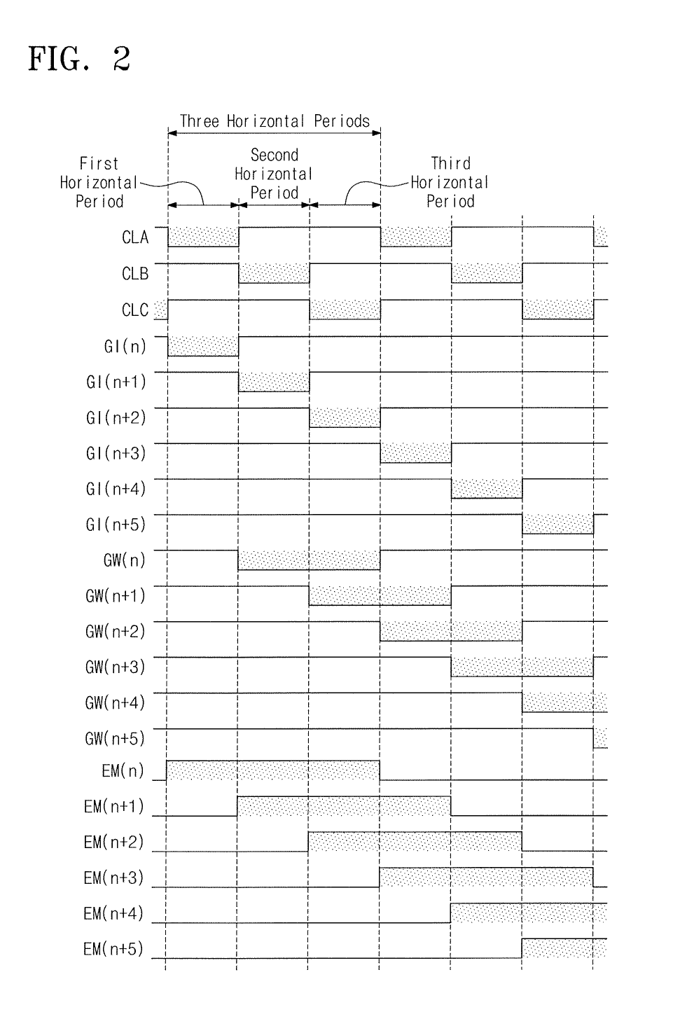

FIG. 2 is a timing chart illustrating an operation in a display device 100 according to an exemplary embodiment of the present inventive concept. FIG. 2 illustrates a timing chart of when a data update period includes first through third horizontal periods as an example. For example, the first horizontal period, the second horizontal period, and the third horizontal period of FIG. 2 represent a single data update period for a certain pixel circuit, which is connected to a data line (e.g., DTk(x)) through a data selection switch turned on based on a switching control signal CLA.

The reference characters “CLA”, “CLB”, and “CLC” shown in FIGS. 1 and 2 correspond to switching control signals. Hereinafter, the switching control signals CLA, CLB, CLC may collectively be referred to as “switching control signal CL”.

As shown in FIG. 1, the switching control signal CLA controls to turn on or turn off a data selection switch connected to the data line DT1(x), the switching control signal CLB controls to turn on or turn off a data selection switch connected to the data line DT2(x), and the switching control signal CLC controls to turn on or turn off a data selection switch connected to the data line DT3(x). In addition, as shown in FIG. 2, the switching control signals CLA, CLB, and CLC turn on data selection switches in different horizontal periods one from another.

Accordingly, in the display device 100, since data selection switches, for example, each of which is turned on or turned off based on one of the switching control signals CLA, CLB, and CLC, are respectively connected to a group of data lines (e.g., DT1(x), DT2(x), and DT3(x)) disposed to correspond to a column of the plurality of pixel circuits, the group of data lines (e.g., DT1(x), DT2(x), or DT3(x)) are connected to driver outputs (e.g., 106-1 through 106-6) in different horizontal periods from each other.

In addition, signals GI(y), GW(y), and EM(y) shown in FIG. 2 may correspond to various control signals CLRS supplied to a pixel circuit.

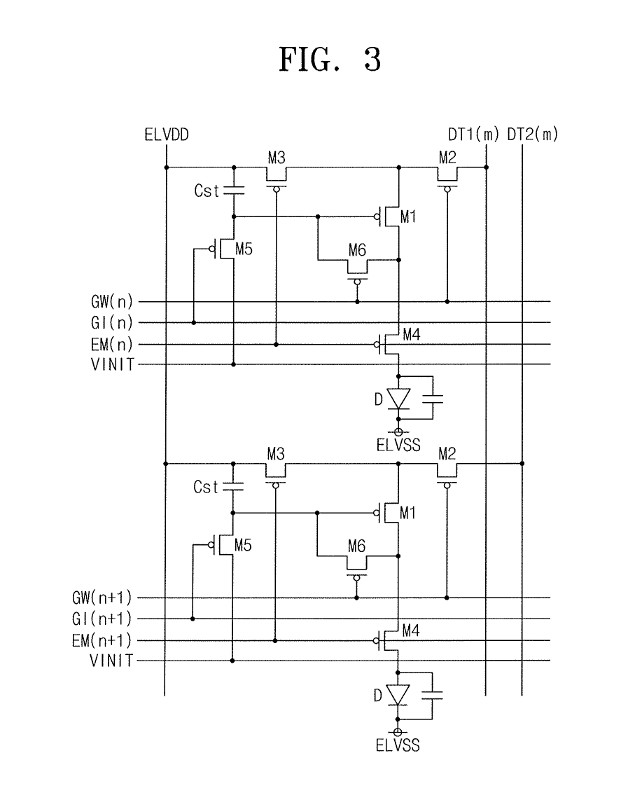

FIG. 3 is a view illustrating a configuration of a pixel circuit in a display device 100 according to an exemplary embodiment of the present inventive concept. FIG. 3 illustrates two pixel circuits which are adjacently disposed in a certain same column of the plurality of pixel circuits disposed in a matrix as shown in FIG. 1. One of the two adjacent pixel circuits in the same column is connected to a data line DT1(m), and another one of the two adjacent pixel circuits in the same column is connected to a data line DT2(m). Hereinafter, a pixel circuit connected to the data line DT1(m) is referred to as a “pixel circuit 1”, and a pixel circuit connected to the data line DT2(m) is referred to as a “pixel circuit 2”.

For example, each of the pixel circuit 1 and the pixel circuit 2 includes a light emitting device D, a holding capacitor Cst, a driving transistor M1, a switch transistor M2, a switch transistor M3, a switch transistor M4, a switch transistor M5, and a diode transistor M6.

The light emitting device D emits light with an amount according to a level of current applied thereto. For example, the light emitting device D may include an organic EL device. As described above, a pixel circuit according to an exemplary embodiment of the present inventive concept is not limited to a configuration having the light emitting device D. In an exemplary embodiment of the present inventive concept, the pixel circuit may have a configuration having a liquid crystal device.

The holding capacitor Cst holds (e.g., maintains) a voltage value corresponding to data provided through the data line DT (e.g., DT1(m) or DT2(m)). The holding capacitor Cst may include a capacitance device, such as a capacitor, having a predetermined capacitance. For example, the holding capacitor Cst may be implemented using parasite capacitance in a pixel circuit.

The driving transistor M1 may serve to control light emission of the light emitting device D. A gate (for example, a control terminal) of the driving transistor M1 is connected to the holding capacitor Cst. For example, when the driving transistor is turned on based on data (e.g., a voltage value) held (e.g., maintained) in the holding capacitor Cst, the light emitting device D may emit light. When the driving transistor is turned off based on data (e.g., a voltage value) held (e.g., maintained) in the holding capacitor Cst, the light emitting device D may not emit light.

The switch transistor M2 serves to control a pixel circuit write timing corresponding to, e.g., the pixel circuit 1 or 2. The switch transistor M2 is turned on or turned off according to a control signal GW(y) (e.g., GW(n) or GW(n+1)) supplied to a gate of the switch transistor M2, so that the switch transistor M2 controls connection between a pixel circuit (e.g., the pixel circuit 1 or 2) and the data line (e.g., DT1(m) or DT2(m)) where data is supplied.

The switch transistors M3 and M4 are turned on or turned off according to a control signal EM(y) (e.g., EM(n) or EM(n+1)) supplied to a gate of each of the switch transistors M3 and M4, so that switch transistors M2 and M4 control the light emission and non-light emission of the light emitting device D.

The switch transistor M5 initializes (e.g., resets or discharges) a voltage value VINIT held in the holding capacitor Cst. When the voltage held in the holding capacitor Cst is initialized, the gate of the driving transistor M1 is initialized. The switch transistor M5 is turned on or turned off according to a control signal GI(n) supplied to a gate of the switch transistor M5.

One terminal (for example, a drain) of the diode transistor M6 is connected to the gate of the driving transistor M1, and another terminal (for example, a source) of the diode transistor M6 is connected to one terminal (for example, a drain) of the driving transistor M1. For example, the diode transistor M6 is turned on or turned off on the basis of the control signal GW(y) applied to a gate of the diode transistor M6. When the diode transistor M6 is turned on, the driving transistor M1 is connected to a diode (e.g., the light emitting device D).

A pixel circuit according to an exemplary embodiment of the present inventive concept may include a configuration shown in FIG. 3.

However, a configuration of a pixel circuit according to an exemplary embodiment of the present inventive concept is not limited to the configuration shown in FIG. 3. For example, a pixel circuit according to an exemplary embodiment of the present inventive concept may have an arbitrary configuration such that a data update period is divided into a data line write period and a pixel circuit write period and light (for example, light emitted from a light emitting device or light emitted from a light source) is outputted according to data written during a pixel circuit write period.

As shown in FIGS. 2 and 3, in the display device 100, data line write is performed in a first horizontal period, and pixel write is performed in a second horizontal period and a third horizontal period based on the switching control signal CL and the control signal GW(y). For example, the first horizontal period among the three horizontal periods (e.g., a data update period) corresponds to a data line write period, and the second horizontal period and the third horizontal period among the three horizontal periods correspond to a pixel circuit write period.

Accordingly, in the display device 100, each of the data line write period and/or the pixel circuit write period may extend such that the data line write and the pixel circuit write are performed during a sufficient time. Accordingly, the display device 100 may reduce the possibility of the lack of data line write or the lack of time for compensating a threshold value of the driving transistor M1, and thus, may reduce image quality deterioration due to the lack of data line write or the lack of time for compensating a threshold value of the driving transistor M1.

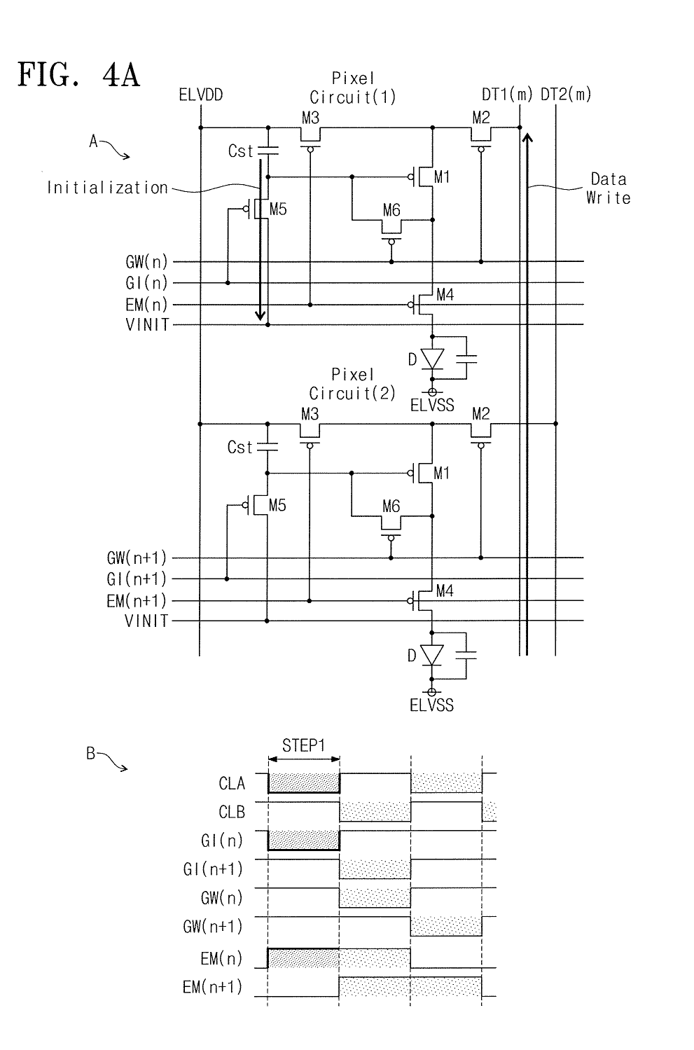

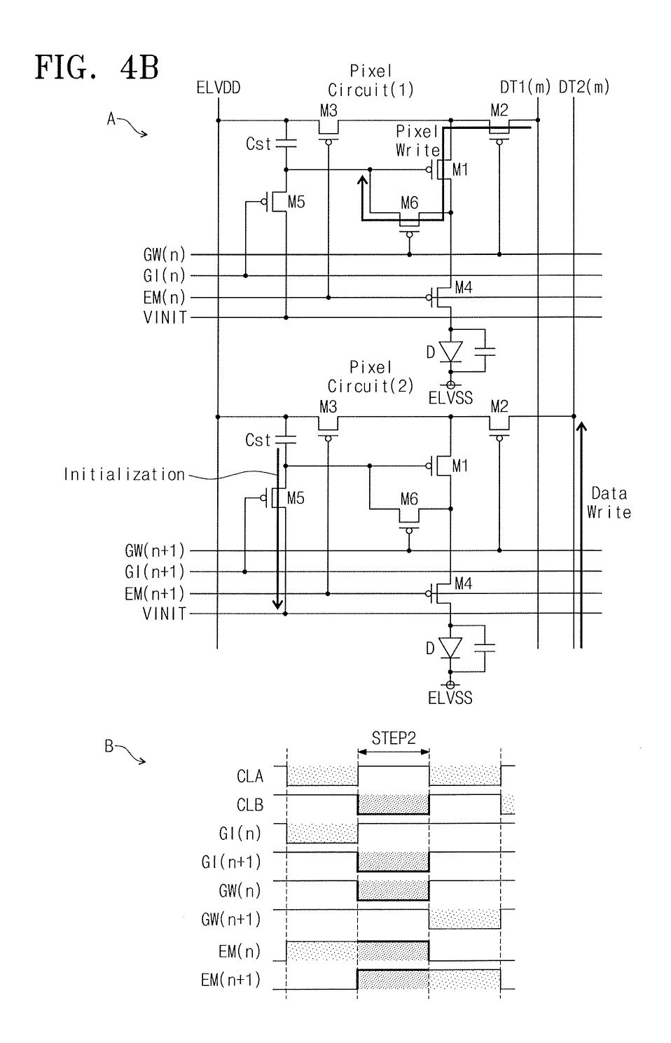

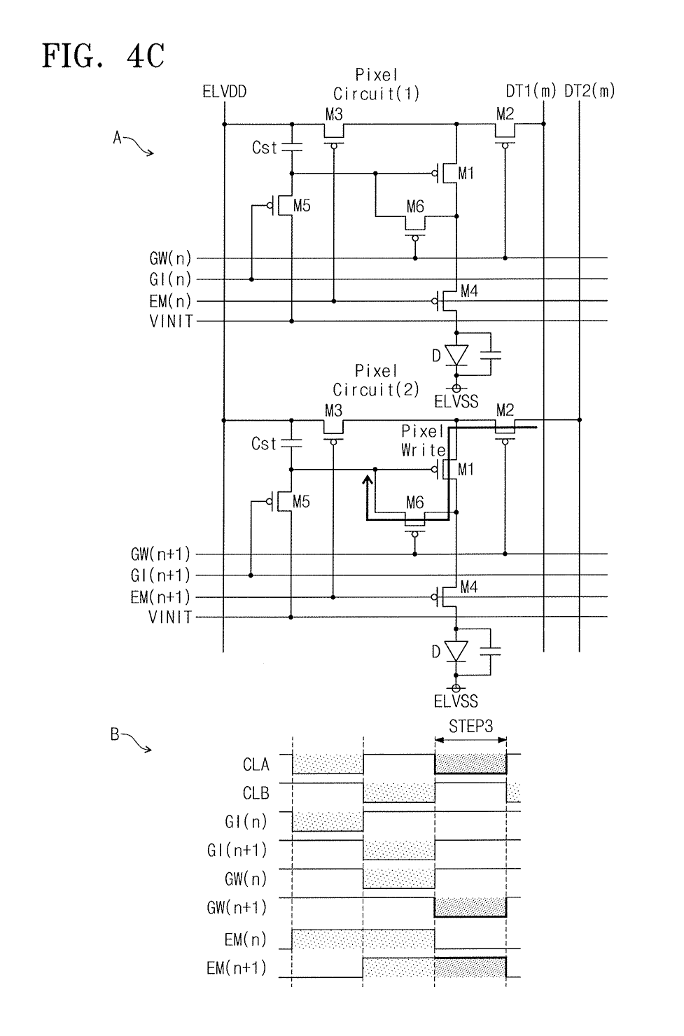

Hereinafter, the operation of performing data update in the display device 100 according to an exemplary embodiment of the present inventive concept will be described with reference with FIGS. 3 and 4A through 4C.

An operation of data update in the display device 100 including the pixel circuit shown in FIG. 3, according to an exemplary embodiment of the present inventive concept will be described below.

FIGS. 4A to 4C are views illustrating an operation of data update of the display device 100 according to an exemplary embodiment of the present inventive concept. When a switching control signal CL and various control signals CLRS are provided as shown in “B” of each of FIGS. 4A to 4C, “A” shown in each of FIGS. 4A to 4C represents an operation of two pixel circuits (e.g., the pixel circuit 1 and the pixel circuit 2) shown in FIG. 3.

For example, the display device 100 performs the operation of data update through first through third basic steps STEP1 through STEP3 as described below.

FIG. 4A illustrates the first step STEP1. In the display device 100, when a data selection switch connected to the data line DT1(m) is turned on according to the switching control signal CLA, data write is performed on the data line DT1(m).

In addition, the switch transistor M5 is turned on based on the control signal GI(n), and the holding capacitor Cst in the pixel circuit 1 is initialized.

In addition, the switch transistors M3 and M4 are turned off based on the control signal EM(n), and the light emitting device D becomes a non-light emission state in the pixel circuit 1.

FIG. 4B illustrates the second step STEP2. Referring to FIG. 4B, the switch transistors M2 and M6 are turned on based on the control signal GW(n) in the pixel circuit 1 and data written to the data line DT1(m) is transmitted to the pixel circuit 1. In the pixel circuit 1, data written to the data line DT1(m) is written (e.g., transferred) to the holding capacitor Cst of the pixel circuit 1 through the switch transistors M2, the driving transistor M1, and the switch transistor M6. In addition, in the pixel circuit 1, the switch transistors M3 and M4 maintain the turned off state based on the control signal EM(n), and the light emitting device D maintains the non-light emission state.

Referring to FIG. 4B, when a data selection switch connected to the data line DT2(m) is turned on based on the switching control signal CLB, data write is performed on the data line DT2(m).

In addition, the switch transistor M5 is turned on based on the control signal GI(n+1) and the holding capacitor Cst in the pixel circuit 2 is initialized.

In addition, in the pixel circuit 2, the switch transistors M3 and M4 are turned off based on the control signal EM(n+1), and the light emitting device D becomes a non-light emission state.

FIG. 4C illustrates the third step STEP3. Referring to FIG. 4C, the switch transistors M2 and M6 of the pixel circuit 2 are turned on based on the control signal GW(n+1), and data written to the data line DT2(m) is transmitted to the pixel circuit 2. In the pixel circuit 2, data written to the data line DT2(m) is written (e.g., transferred) to the holding capacitor Cst of the pixel circuit 2 through the switch transistors M2, the driving transistor M1, and the switch transistor M6 of the pixel circuit 2. In the pixel circuit 2, the switch transistors M3 and M4 maintain the turned off state based on the control signal EM(n+1), and the light emitting device D maintains the non-light emission state.

In addition, in the display device 100, when a data selection switch connected to the data line DT1(m) is turned on according to the switching control signal CLA, data write is performed on the data line DT1(m).

For example, in the display device 100, data update is performed through the first through third steps STEP1 through STEP3 as shown in FIGS. 4A to 4C.

As described above, the display device 100 of FIG. 1 according to an exemplary embodiment of the present inventive concept includes a configuration such that three data lines (e.g., DT1(x) through DT3(x)) are disposed to correspond to each column (e.g., an x-th column) of a plurality of pixel circuits disposed in a matrix, and data, e.g., corresponding to each of three primary colors of light, is supplied to each data line (e.g., DTk(x)). However, a configuration of the display device according to an exemplary embodiment of the present inventive concept is not limited to the configuration of FIG. 1.

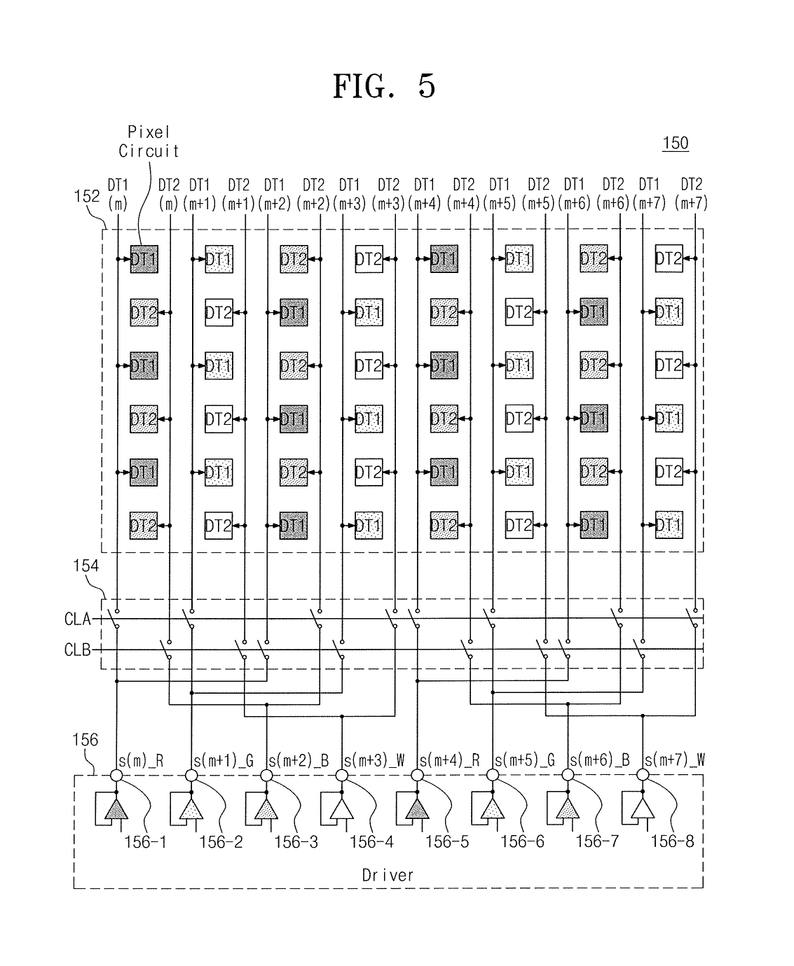

FIG. 5 is a view illustrating a configuration of a display device 150 according to an exemplary embodiment of the present inventive concept.

The display device 150 shown in FIG. 5 may include a display unit 152, a switching unit 154, and a driver 156.

The display unit 152 includes a plurality of pixel circuits disposed in a matrix, and displays an image on a display screen based on data supplied through a plurality of data lines. As shown in FIG. 5, 6×8 pixel circuits (e.g., the number of pixel circuits in a row direction is six and the number of pixel circuits in a column direction is eight) are disposed in a matrix. However, the number of pixel circuits included in the display device of the present inventive concept is not limited to the number of pixel circuits in the configuration of FIG. 5.

For example, the display device 150 includes the same pixel circuit as the display device 100 shown in FIG. 1.

Referring to the display device 150 of FIG. 5, two data lines DT1(x) and DT2(x) (e.g., when n is two) are disposed to correspond to each column (e.g., an x-th column) of the plurality of pixel circuits disposed in a matrix. For example, one of the two data lines DT1(x) and DT2(x) is disposed at one side (e.g., a left side) of the corresponding column (e.g., an x-th column) of the plurality of pixel circuits, another one of the two data lines DT1(x) and DT2(x) is disposed at another side (e.g., a right side) of the corresponding column of the plurality of pixel circuits. Referring to FIG. 5, eight columns of the plurality of pixel circuits of the display device 150 are illustrated as an example. In this case, the number of data lines in the display device 150 may be 16. However, the number of data lines of the present inventive concept is not limited thereto.

Referring to FIG. 5, each of first pixel circuits arranged in a same column among a plurality of pixel circuits disposed in a matrix is connected to one of the data lines DT1(x) and DT2(x). For example, the data lines DT1(x) and DT2(x) are disposed to correspond to the same column to which the first pixel circuits belong. For example, a data line (e.g., DTi(x)) connected to a pixel circuit arranged in a first column (e.g., the x-th column) is different from a data line (e.g., DTj(x)) connected to a pixel circuit arranged in a second column (e.g., an (x+1)-th column). In addition, for example, pixel circuits, which are adjacently disposed in the same column (or row), are respectively connected to different types of data lines (e.g., DTk(x)) of a group of data lines corresponding to a column (e.g., an x-th column) of the plurality of pixel circuits. For example, pixel circuits which are adjacently disposed in the column direction are connected to the data lines DT1(x) and DT2(x), respectively.

Accordingly, in the display device 150, a data line (e.g., DTi(x)) connected to a first pixel circuit is different from a data line (e.g., DTj(x)) connected to a second pixel circuit which is adjacent to the first pixel circuit in a row or column direction.

For example, in the display device 150, at least one signal line to which various control signals CLRS are supplied is disposed to correspond to each row of the plurality of pixel circuits in the display device 150.

The switching unit 154 includes a plurality of data selection switches, each of which corresponds to each data line (e.g., DTk(x)).

Referring to FIG. 5, each data selection switch in the switching unit 154 is connected to one of a plurality of data lines and one of a plurality of driver outputs (e.g., 156-1 through 156-8) of the driver 156. In addition, when each data selection switch of the switching unit 154 is turned on or turned off on the basis of a switching control signal, a corresponding data line (e.g., DTk(x)) is selectively connected to a corresponding driver output (e.g., one of 156-1 through 156-8).

Each driver output (e.g., each of 156-1 through 156-8) of the driver 156 outputs, for example, data amplified by an amplifier. As shown in FIG. 5, for example, the driver 156 includes eight driver outputs 156-1 through 156-8. The eight driver outputs 156-1 through 156-8 include two driver outputs (e.g., 156-1 and 156-5) which output data s(m)_R and S(m+4)_R, respectively, each of which corresponds to a red color, two driver outputs (e.g., 156-2 and 156-6) which output data s(m+1)_G and S(m+5)_G, respectively, each of which corresponds to a green color, two driver outputs (e.g., 156-3 and 156-7) which output data s(m+2)_B and S(m+6)_B, respectively, each of which corresponds to a blue color, and two driver outputs (e.g., 156-4 and 156-8) which output data s(m+3)_W and S(m+7)_W, respectively, each of which corresponds to a white color.

In addition, the two driver outputs (e.g., 156-4 and 156-8) which output data s(m+3)_W and S(m+7)_W, respectively, corresponding to a white color may be driver outputs which output data corresponding to another color (e.g., a green color) other than the white color.

As shown in FIG. 5, in the display device 150, an output of each of the driver outputs 156-1 through 156-8 is fixed (e.g., unchanged) to correspond to a certain color. For example, data corresponding to a fixed color (e.g., a color of light emitted through a pixel circuit) is supplied to each data line of a group of data lines (e.g., DT1(k) and DT2(k)). For example, a color represented by data supplied to each data line of the group of data lines (e.g., DT1(x) and DT2(x)) is fixed (e.g., not changed). For example, one data line (e.g., DT1(k)) of the group of data lines (e.g., DT1(k) and DT2(k)) may be disposed at one side (e.g., a left side) of a corresponding pixel circuit column, and another data line (e.g., DT2(k) of the group of data lines (e.g., DT1(k) and DT2(k)) may be disposed at another side (e.g., a right side) of the pixel circuit column. Each data line of the group of data lines (e.g., DT1(k) and DT2(k)) may be connected to each of the data selection switches.

Referring to FIG. 5, a data line (e.g., DTi(x)) connected to a first pixel circuit is different from a data line (e.g., DTj(x)) connected to a second pixel circuit which is adjacent to the first pixel circuit in a row or column direction.

Accordingly, in a data update period, data corresponding to a fixed color (e.g., a predetermined color, or one of colors of light emitted through the plurality of pixel circuits) is written (e.g., provided) to a first pixel circuit through a first data line (e.g., DTi(x)), and data to corresponding to a color is written to a second pixel circuit through a second data line (e.g., DTj(x)). The second pixel circuit is adjacent to the first pixel circuit in a row or column direction in the display device 150.

An operation of the display device 150 according to an exemplary embodiment of the present inventive concept will be described.

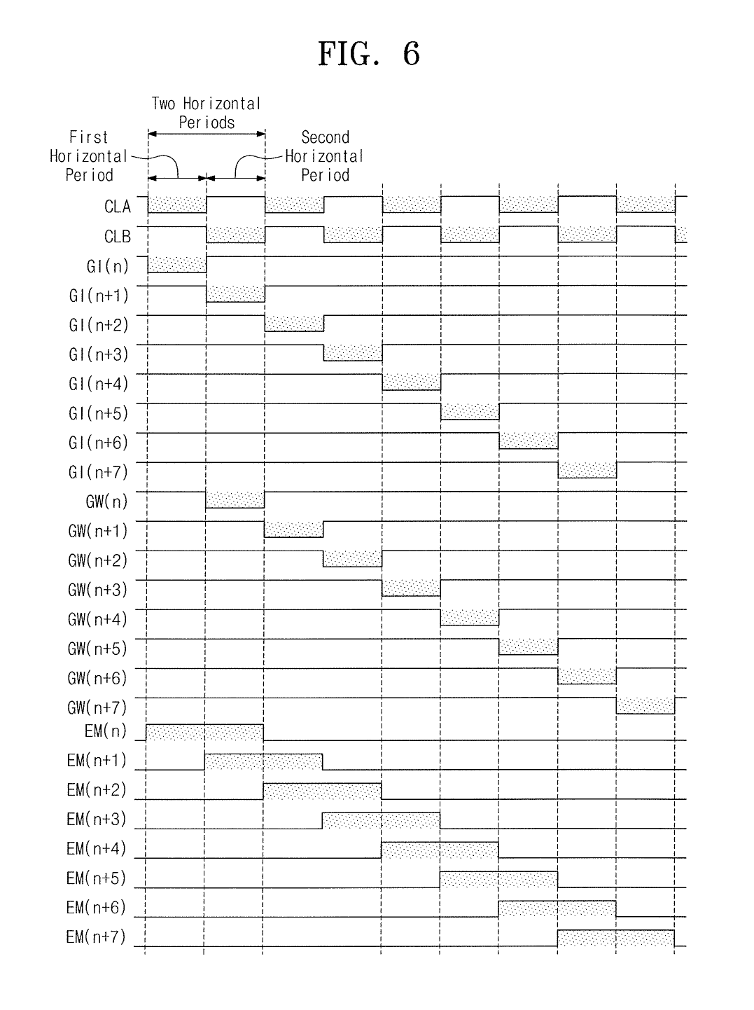

FIG. 6 is a timing chart illustrating an operation of the display device 150 according to an exemplary embodiment of the present inventive concept. FIG. 6 illustrates waveforms of a switching control signal CL and various control signals CLRS when each pixel circuit of the display device 150 has the same configuration as the pixel circuit of FIG. 3.

FIG. 6 illustrates a timing chart of when a data update period includes two horizontal periods (e.g., a first horizontal period and a second horizontal period) as an example. For example, the two horizontal periods shown in FIG. 6 represent a single data update period for a certain pixel, which is connected to a data line (e.g., DTk(x)) through a data selection switch turned on based on a switching control signal CLA.

As shown in FIG. 5, the switching control signal CLA controls to turn on or turn off a data selection switch connected to the data line DT1(x), and the switching control signal CLB controls to turn on or turn off a data selection switch connected to the data line DT2(x). In addition, for example, as shown in FIG. 6, the switching control signals CLA and CLB turn on data selection switches in different horizontal periods one from another.

Accordingly, in the display device 150, since data selection switches, for example, each of which is turned on or turned off based on one of the switching control signals CLA and CLB, are respectively connected to a group of data lines (e.g., DT1(x) and DT2(x)) disposed to correspond to a column of the plurality of pixel circuits, the group of data lines (e.g., DT1(x) and DT2(x)) are respectively connected to driver outputs (e.g., 156-1 through 156-8) in different horizontal periods from each other.

In addition, as shown in FIGS. 3, 5, and 6, in the display device 150, data line write is performed in a first horizontal period and pixel write is performed in a second horizontal period based on the switching control signal CL and the control signal GW(y). For example, the first horizontal period among the two horizontal periods (e.g., a data update period) corresponds to a data line write period, and the second horizontal period among the two horizontal periods corresponds to a pixel circuit write period.

Accordingly, in the display device 150, each of the data line write period and/or the pixel circuit write period may extend such that the data line write and the pixel circuit write are performed during a sufficient time. Accordingly, the display device 150 may reduce the possibility of the lack of data line write or the lack of time for compensating a threshold value of the driving transistor M1, the display device 150 may reduce image quality deterioration due to the lack of data line write or the lack of time for compensating a threshold value of the driving transistor M1.

A configuration of a display device according to an exemplary embodiment of the present inventive concept is not limited to the configurations of the display device 100 of FIG. 1 and the display device 150 of FIG. 5.

In an exemplary embodiment of the present inventive concept, the driver 106 shown in FIG. 1 or the driver 156 shown in FIG. 5 may be implemented as an external driver of the display device 100 or the display device 150. The display device (e.g., 100 of FIG. 1 or 150 of FIG. 5) according to an exemplary embodiment of the present inventive concept may further include a driver that outputs various control signals CLRS.

In the display device (e.g., 100 of FIG. 1 or 150 of FIG. 5) according to an exemplary embodiment of the present inventive concept, two or more data lines (e.g., DT1(k) through DT3(k) of FIG. 1 or DT1(k) and DT2(k) of FIG. 5) are disposed to correspond to each column (or row) (e.g., an x-th column (or row)) of a plurality of pixel circuits disposed in a matrix, and a data update period includes a data line write period and a pixel circuit write period. Referring to FIG. 2 or 6, a data update period includes a plurality of horizontal periods. Some of the plurality of horizontal periods corresponds to the data line write period, and horizontal periods excluding a data line write period among the plurality of horizontal periods correspond to the pixel circuit write period. Accordingly, the display device according to an exemplary embodiment of the present inventive concept may have an extended data write time.

In addition, in the display device (e.g., the display device 100 or 150) according to an exemplary embodiment of the present inventive concept, for example, since a connection relationship between a data line and a driver output is fixed, data corresponding to a fixed color (e.g., a predetermined color, or one of colors of light emitted through the plurality of pixel circuits) is supplied, without being changed in color, to a corresponding data line (e.g., DTk(x)) of a group of data lines disposed to correspond to a column (or row) (e.g., an x-th column (or row)) of a plurality of pixel circuits. For example, color represented data supplied to each data line (e.g., DTk(x)) is fixed (e.g., not changed). In addition, in the display device (e.g., the display device 100 or 150) according to an exemplary embodiment of the present inventive concept, a data line (e.g., DTi(x)) connected to a first pixel circuit is different from a data line (e.g., DTj(x)) connected to a second pixel circuit which is adjacent to the first pixel circuit in a row or column direction.

Accordingly, in the display device (e.g., the display device 100 or 150) according to an exemplary embodiment of the present inventive concept, image quality deterioration such as line defects due to a data line variation is reduced.

Accordingly, the display device (e.g., the display device 100 or 150) according to an exemplary embodiment of the present inventive concept may prevent image quality deterioration due to the lack of data write or a variation in a plurality of data lines.

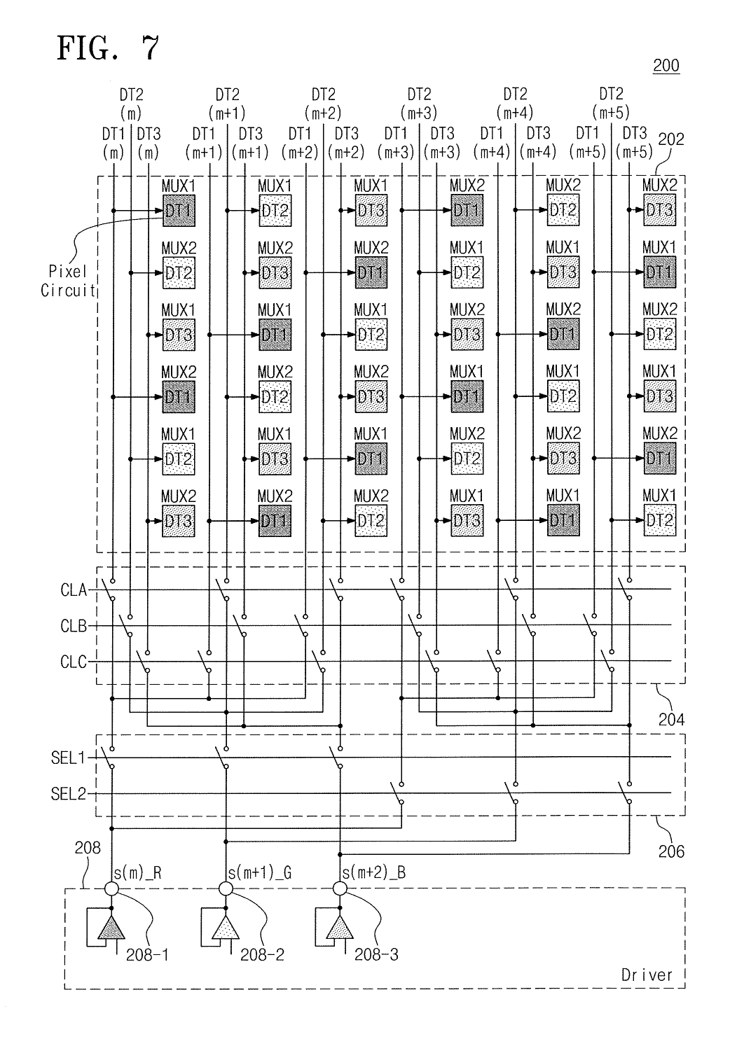

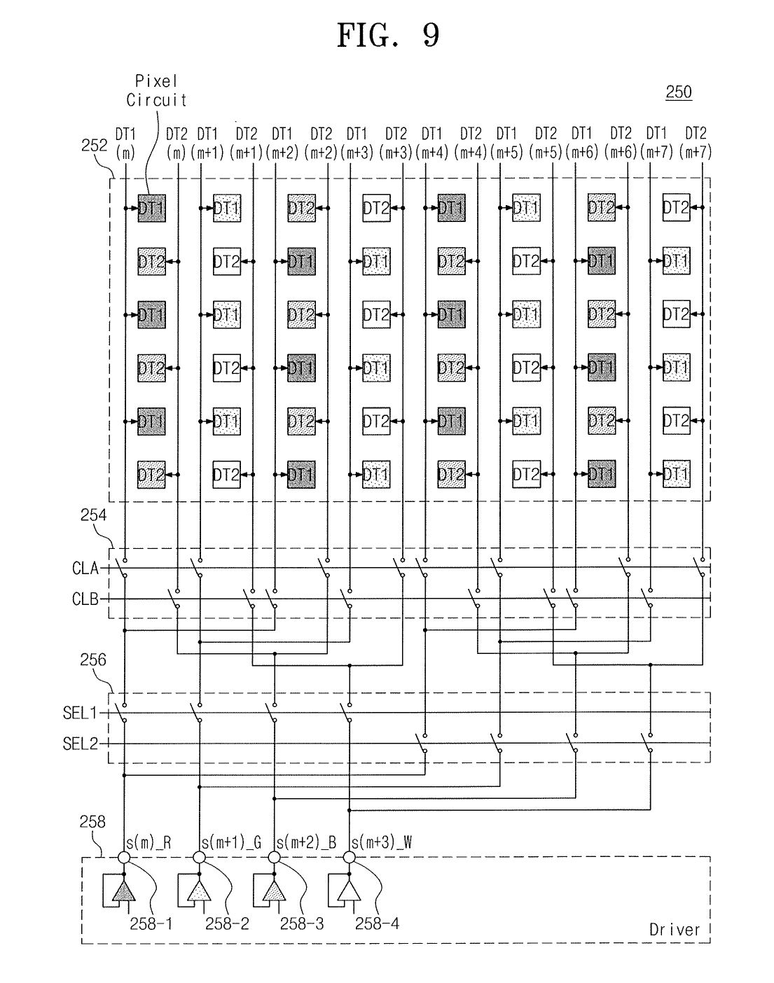

Hereinafter, a display device (e.g., 200 of FIG. 7 or 250 of FIG. 9) according to an exemplary embodiment of the present inventive concept will be described. For example, a configuration and operation of a display device (e.g., 200 of FIG. 7 or 250 of FIG. 9) capable of performing a plurality of writes during a single horizontal period will be described. In an exemplary embodiment of the present inventive concept, the display device (e.g., 200 of FIG. 7 or 250 of FIG. 9) may perform data write twice (e.g., MUX1 and MUX2) during a single horizontal period. This will be described later.

FIG. 7 is a view illustrating a configuration of a display device 200 according to an exemplary embodiment of the present inventive concept.

In the display device 200, a data update period includes a data line write period and a pixel circuit write period, and a plurality of data writes are performed during a single horizontal period of each of the data line write period and the pixel circuit write period. The display device 200 may be configured to have two sub data write periods (e.g., MUX1 and MUX2) will be described during a single horizontal period.

For example, the display device 200 shown in FIG. 7 includes a display unit 202, a first switching unit 204, a second switching unit, and a driver 208.

The display unit 202 includes a plurality of pixel circuits disposed in a matrix and displays an image based on data supplied through a plurality of data lines, on a display screen. As shown in FIG. 7, 6×6 pixel circuits (e.g., the number of pixel circuits in a row direction is six and the number of pixel circuits in a column direction is six) are disposed in a matrix.

Each pixel circuit of the display device 200 may have substantially the same configuration as the pixel circuit of FIG. 3. In an exemplary embodiment of the present inventive concept, each pixel circuit of the display device 200 may have substantially the same configuration as the pixel circuit of FIG. 3 other than that the pixel circuit of the display device 200 further includes a multiplexer. Hereinafter, a case where each pixel circuit of the display device 200 have substantially the same configuration as the pixel circuit FIG. 3 will be described as an example. However, the present inventive concept is not limited thereto.

In addition, in the display device 200, each group of data lines including three data lines DT1(x), DT2(x), and DT3(x) (e.g., when n is three) is disposed to correspond to each column (e.g., an x-th column) of a plurality of pixel circuits.

Referring to FIG. 7, each of first pixel circuits arranged in a certain same column among a plurality of pixel circuits disposed in a matrix is connected to one of the data lines DT1(x), DT2(x), and DT3(x). For example, the data lines DT1(x), DT2(x), and DT3(x) are disposed to correspond to the same column to which the first pixel circuits belong. For example, a data line (e.g., DTi(x)) connected to a pixel circuit arranged in a first column (e.g., an x-th column) is different from a data line (e.g., DTj(x+1)) connected to a pixel circuit arranged in a second column (e.g., an (x+1)-th column adjacent to the x-th column).

As shown in FIG. 7, a data line (e.g., DTi(x)) connected to a pixel circuit arranged in a column (e.g., an x-th column) is different from a data line (e.g., DTj(x)) connected to a pixel circuit arranged in the same column (e.g., an x-th column).

Accordingly, in the display device 200, a data line connected to a first pixel circuit is different from a data line connected to a second pixel circuit which is adjacent to the first pixel circuit in a row or column direction.

For example, in the display device 00, at least one signal line to which various control signals CLRS are supplied is disposed to correspond to each row of a plurality of pixel circuits in the display device 200.

The first switching unit 204 includes a plurality of data selection switches, each of which corresponds to each data line (e.g., DTk(x)).

Referring to FIG. 7, each data selection switch in the first switching unit 204 is connected to one of a plurality of data lines and one of a plurality of driver outputs (e.g., 208-1 through 208-3) of the driver 208 through a switch of the second switching unit 206. In addition, when each data selection switch of the first switching unit 204 is turned on or turned off on the basis of a switching control signal, a corresponding data line (e.g., DTk(x)) is selectively connected to a corresponding driver output (e.g., one of 208-1 through 208-3).

The second switching unit 206 includes a plurality of switches, each of which is connected to one of a plurality of driver outputs 208-1 through 208-3 of the driver 208.

Each of the plurality of switches in the second switching unit 206, for example, is connected to some of a plurality of data selection switches included in the first switching unit 204. When each switch of the second switching unit 206 is turned on or turned off on the basis of a selection signal SEL1 or SEL2, as shown in FIG. 7, which may collectively be referred to as a “selection signal SEL”, each of the plurality of driver outputs 208-1 through 208-3 is selectively connected to each of the plurality of selection switches based on the selection signal SEL.

Since the display device 200 includes the first switching unit 204 and the second switching unit 206, and a plurality of data line writes are performed in the first horizontal period, e.g., corresponding to the data line period, the number of driver outputs (e.g., 208-1 through 208-3) of the driver 208 may be reduced compared to the configuration of each of FIGS. 1 and 5.

Each driver output (e.g., one of 208-1 through 208-3) of the driver 208 output, for example, data amplified by an amplifier. As shown in FIG. 7, for example, the driver 208 includes three driver outputs 208-1 through 208-3. The three driver outputs 208-1 through 208-3 include a driver output 208-1 which outputs data s(m)_R corresponding to a red color, a driver output 208-2 which outputs data s(m+1)_G corresponding to a green color, and a driver output 208-3 which outputs data s(m+2)_B corresponding to a blue color.

As shown in FIG. 7, a driver output (e.g., 208-1) which outputs the data s(m) is connected to a data line DT1(x) through a corresponding switch of the second switching unit 206 and a corresponding data selection switch of the first switching unit 204. In addition, a driver output (e.g., 208-2) which outputs the data s(m+1)_G is connected to a data line DT2(x) through a corresponding switch of the second switching unit 206 and a corresponding data selection switch of the first switching unit 204. In addition, a driver output (e.g., 208-3) which outputs the data s(m+2)_B is connected to a data line DT3(x) through a corresponding switch of the second switching unit 206 and a corresponding data selection switch of the first switching unit 204.

Accordingly, in the display device 200, data corresponding to a fixed color is supplied to each data line of a group of data lines (e.g., DT1(x) through DT3(x)) disposed to correspond to each column (e.g., x-th column) of the plurality of pixel circuits. For example, a color represented by data supplied to each data line of a group of data lines (e.g., DT1(x) through DTn(x)) disposed to correspond to each column (e.g., x-th column) of the plurality of pixel circuits is fixed (e.g., not changed).

Referring to FIG. 7, a data line (e.g., DTi(x)) connected to a first pixel circuit is different from a data line (e.g., DTj(x)) connected to a second pixel circuit which is adjacent to the first pixel circuit in a row or column direction.

Accordingly, in a data update period, data corresponding to a fixed color (e.g., a predetermined color, or one of colors of light emitted through the plurality of pixel circuits) is written (e.g., provided) to a first pixel circuit through a first data line (e.g., DTi(x)), and data corresponding to a color is written to a second pixel circuit through a second data line (e.g., DTj(x)). The second pixel circuit is adjacent to the first pixel circuit in a row direction or a column direction in the display device 200.

The display device 200 according to an exemplary embodiment of the present inventive concept has a configuration shown in FIG. 7.

An operation of the display device 200 according to an exemplary embodiment of the present inventive concept will be described.

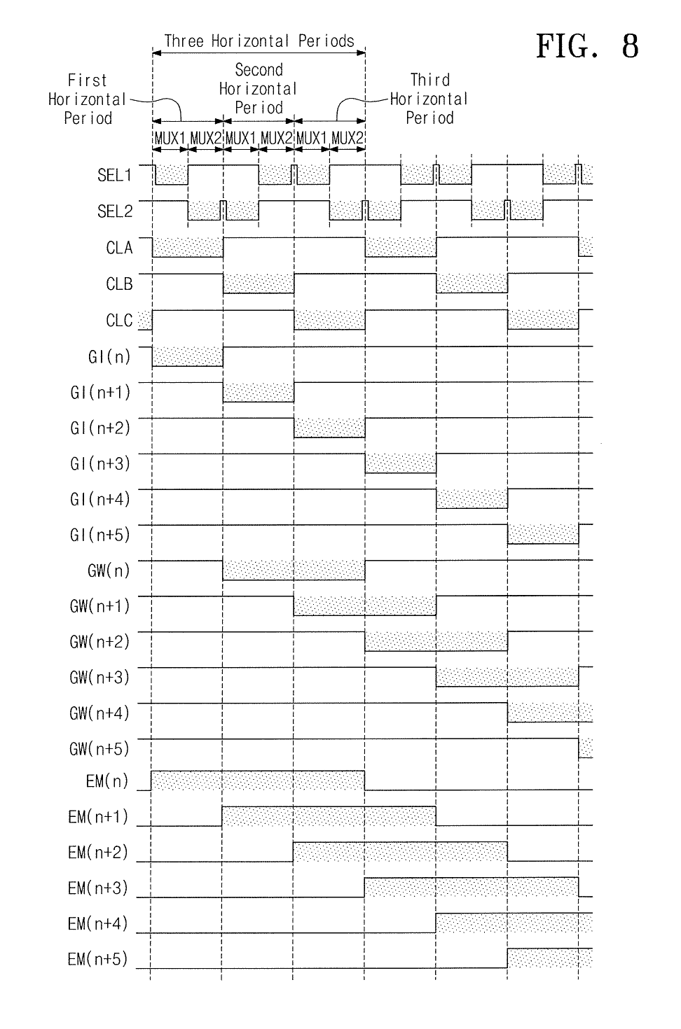

FIG. 8 is a timing chart illustrating an operation of the display device 200 according to an exemplary embodiment of the present inventive concept. FIG. 8 illustrates a timing chart of when a data update period includes three horizontal periods (e.g., a first horizontal period, a second horizontal period, and a third horizontal period) and in each horizontal period, two times of write is performed. In addition, the three horizontal periods shown in FIG. 8 represent a single data update period for a certain pixel circuit, which is connected to a data line (e.g., DTk(x)) through a data selection switch turned on based on a switching control signal CLA.

As shown in FIG. 7, a data selection switch connected to each of the data lines DT1(x), DT2(x), and DT3(x) is turned on or turned off based on a corresponding one of the switching control signals CLA, CLB, and CLC. In addition, for example, as shown in FIG. 8, the switching control signals CLA, CLB, and CLC turn on data selection switches in different horizontal periods one from another.

Accordingly, in the display device 200, since data selection switches, for example, each of which is turned on or turned off based on one of the switching control signals CLA, CLB, and CLC, are respectively connected to a group of data lines (e.g., DT1(x), DT2(x), and DT3(x)) disposed to correspond to a column of the plurality of pixel circuits, the group of data lines (e.g., DT1(x), DT2(x), and DT3(x)) are respectively connected to driver outputs (e.g., 208-1 through 208-3) in different horizontal periods one from another.

In addition, as shown in FIGS. 3, 7, and 8, in the display device 200, data line write is performed in a first horizontal period and pixel write is performed in a second horizontal period based on the switching control signal CL and the control signal GW(y). For example, the first horizontal period among the two horizontal periods (e.g., a data update period) corresponds to a data line write period, and the second horizontal period among the two horizontal periods corresponds to a pixel circuit write period.

Accordingly, in the display device 200, each of the data line write period and/or the pixel circuit write period may extend such that the data line write and the pixel circuit write are performed during a sufficient time. Accordingly, the display device 200 may reduce the possibility of the lack of data line write or the lack of time for compensating a threshold value of the driving transistor M1, and thus, may reduce image quality deterioration due to the lack of data line write or the lack of time for compensating a threshold value of the driving transistor M1.

In addition, in the display device 200, a data line (e.g., DTk(x)) is supplied with data when a corresponding switch included in the second switching unit 206 is turned on based on the selection signal SEL- and a corresponding data selection switch included in the first switching unit 204 is turned on based on the switching control signal CL. For example, as shown in FIGS. 7 and 8, in the display device 200, the order of writing data to a pixel circuit during one horizontal period varies for pixel circuits adjacent in a column (or row) of a plurality of pixel circuits. For example, the order of writing data to a first pixel circuit during one horizontal period (e.g., a horizontal period of each the data line write period and the pixel circuit write period) is different from the order of writing data to a second pixel circuit adjacent in a column (or row) of a plurality of pixel circuits.

Accordingly, in the display device 200, since a single horizontal period includes a plurality of data write timings, the influence of data line variation may be reduced and thus, image quality deterioration (e.g., line defects) due to the data line variation may be reduced.

As described above with reference to FIG. 7, in the display device 200, three data lines (e.g., DT1(x) through DT3(x)) are disposed to correspond to each column (e.g., an x-th column) of a plurality of pixel circuits disposed in a matrix, and data representing each of three primary colors of light is supplied to each data line (e.g., DTk(x)). However, a configuration of a display device according to an exemplary embodiment of the present inventive concept is not limited to the configuration of FIG. 7.

FIG. 9 is a view illustrating a configuration of a display device 250 according to an exemplary embodiment of the present inventive concept.

For example, the display device 250 shown in FIG. 9 includes a display unit 252, a first switching unit 254, a second switching unit, and a driver 256.

The display unit 252 includes a plurality of pixel circuits disposed in a matrix, and displays an image based on data supplied through a plurality of data lines, on a display screen. As shown in FIG. 9, 6×8 pixel circuits (e.g., the number of pixel circuits in a row direction is six and the number of pixel circuits in a column direction is eight) are disposed in a matrix.

The display device 250, for example, includes the same pixel circuit as the display device 200 shown in FIG. 7.

Referring to the display device 250 of FIG. 9, two data lines DT1(x) and DT2(x) (e.g., when n is two) are disposed to correspond to each column (e.g., an x-th column) of the plurality of pixel circuits disposed in a matrix. For example, one of the two data lines DT1(x) and DT2(x) is disposed at one side (e.g., a left side) of the corresponding column of the plurality of pixel circuits, another one of the two data lines DT1(x) and DT2(x) is disposed at another side (e.g., a right side) of the corresponding column of the plurality of pixel circuits. Referring to FIG. 9, eight columns of the plurality of pixel circuits of the display device 250 are illustrated as an example. In this case, the number of data lines in the display device 250 may be 16. However, the number of data lines of the present inventive concept is not limited thereto.

Referring to FIG. 9, each of first pixel circuits arranged in a certain same column among a plurality of pixel circuits disposed in a matrix is connected to one of the data lines DT1(x) and DT2(x). For example, the data lines DT1(x) and DT2(x) are disposed to correspond to the same column to which the first pixel circuits belong. For example, a data line (e.g., DTi(x)) connected to a pixel circuit arranged in a first column (e.g., an x-th column) is different from a data line (e.g., DTj(x+1)) connected to a pixel circuit arranged in a second column (e.g., an (x+1)-th column adjacent to the x-th column). In addition, a data line (e.g., DTi(x)) connected to a pixel circuit arranged in a column (e.g., an x-th column) is different from a data line (e.g., DTj(x)) connected to a pixel circuit arranged in the same column (e.g., an x-th column).

In the display device 250, a data line (e.g., DTi(x)) connected to a first pixel circuit is different from a data line (e.g., DTj(x)) connected to a second pixel circuit which is adjacent to the first pixel circuit in a row or column direction.

For example, in the display device 250, at least one signal line to which various control signals CLRS are supplied is disposed to correspond to each row of a plurality of pixel circuits in the display device 250.

The first switching unit 254 includes a plurality of data selection switches each corresponding to each data line (e.g., DTk(x)).

Referring to FIG. 9, each data selection switch in the first switching unit 204 is connected to one of a plurality of data lines and one of a plurality of driver outputs (e.g., 258-1 through 258-4) of the driver 258 through a switch of the second switching unit 256. In addition, when each data selection switch of the first switching unit 254 is turned on or turned off on the basis of a switching control signal, a corresponding data line (e.g., DTk(x)) is selectively connected to a corresponding driver output (e.g., one of 258-1 through 258-4).

The second switching unit 256 includes a plurality of switches, each of which is connected to one of a plurality of driver outputs 258-1 through 258-4 of the driver 258.

Each of the plurality of switches in the second switching unit 256, for example, is connected to some of a plurality of data selection switches included in the first switching unit 254. When each switch of the second switching unit 256 is turned on or turned off on the basis of a selection signal SEL, each of the plurality of driver outputs 258-1 through 258-4 is selectively connected to each of the plurality of selection switches based on the selection signal SEL.

Each driver output (e.g., each of 258-1 through 258-4) of the driver 258 outputs, for example, data amplified by an amplifier. As shown in FIG. 9, for example, the driver 258 includes four driver outputs 258-1 through 258-4. The four driver outputs 258-1 through 258-4 include a driver output 258-1 which outputs data s(m)_R corresponding to a red color, a driver output 258-2 which outputs data s(m+1)_G corresponding to a green color is outputted, a driver output 258-3 which outputs data s(m+2)_B corresponding to a blue color, and a driver output 258-4 which outputs data s(m+3)_W corresponding to a white color.

In addition, a driver output (e.g., 258-4) which outputs data s(m+3)_W corresponding to a white color may be a driver output which outputs data corresponding to another color such as green color other than the white color.

As shown in FIG. 9, a driver output (e.g., one of 258-1 through 258-4) connected to a data line (e.g., DTk(x)) is fixed to correspond to a certain color, and data corresponding to a fixed color (e.g., a color of light emitted through a pixel circuit) is supplied to each data line of a group of data lines (e.g., DT1(x) through DT3(x)) disposed to correspond to each column (e.g., an x-th column (or row)) of a plurality of pixel circuits through a switch of the second switching unit 206 and a data selection switch of the first switching unit 204. For example, a color represented by data supplied to each data line of the group of data lines (e.g., DT1(x) through DT3(x)) is fixed (e.g., not changed).

Referring to FIG. 9, a data line (e.g., DTi(x)) connected to a first pixel circuit is different from a data line (e.g., DTj(x)) connected to a second pixel circuit which is adjacent to the first pixel circuit in a row or column direction.

Accordingly, in a data update period, data corresponding to a fixed color (e.g., a predetermined color, or one of colors of light emitted through the plurality of pixel circuits) is written (e.g., provided) to a first pixel circuit through a first data line (e.g., DTi(x)) and data corresponding to another color is written to a second pixel circuit through a second data line (e.g., DTj(x)). The second pixel circuit is adjacent to the first pixel circuit in a row direction or a column direction in the display device 250.

An operation of the display device 250 according to an exemplary embodiment of the present inventive concept will be described.

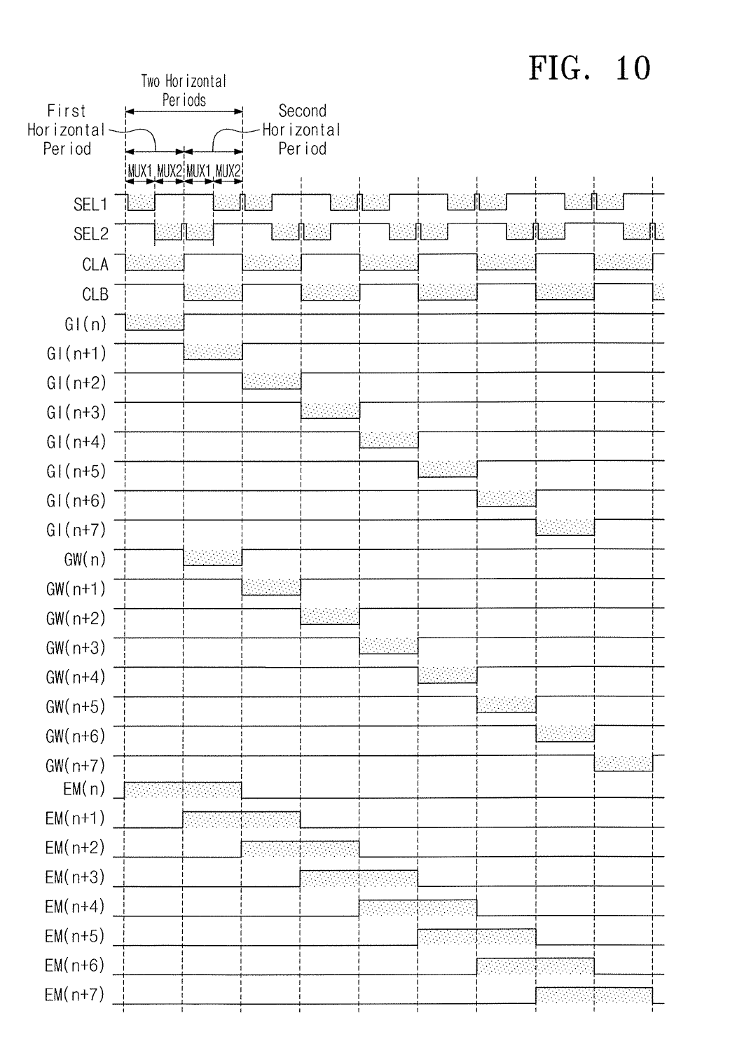

FIG. 10 is a timing chart illustrating an operation of the display device 250 according to an exemplary embodiment of the present inventive concept. FIG. 10 illustrates a timing chart of when a data update period includes two horizontal periods (e.g., a first horizontal period and a second horizontal period) and in each horizontal period, two times of write is performed as shown in, e.g., MUX1 and MUX2 of FIG. 10. In addition, the two horizontal periods shown in FIG. 10 represent a single data update period for a certain pixel circuit, which is connected to a data line (e.g., DTk(x)) through a data selection switch turned on based on a switching control signal CLA.

As shown in FIG. 9, a data selection switch connected to each of the data lines DT1(x) and DT2(x) is turned on or turned off based on a corresponding one of the switching control signals CLA and CLB. In addition, for example, as shown in FIG. 10, the switching control signals CLA and CLB turn on data selection switches in different horizontal periods one from another.

Accordingly, in the display device 250, since data selection switches, for example, each of which is turned on or turned off based on one of the switching control signals CLA and CLB, respectively connected to a group of data lines (e.g., DT1(x) and DT2(x)) disposed to correspond to a column of the plurality of pixel circuits, the group of data lines (e.g., DT1(x) and DT2(x)) are respectively connected to driver outputs (e.g., 258-1 through 258-4) in different horizontal periods one from another.

In addition, as shown in FIGS. 3, 9, and 10, in the display device 250, data line write is performed in a first horizontal period and pixel write is performed in a second horizontal period based on the switching control signal CL and the control signal GW(y). For example, the first horizontal period among the two horizontal periods (e.g., a data update period) corresponds to a data line write period, and the second horizontal period among the two horizontal periods corresponds to a pixel circuit write period.

Accordingly, in the display device 250, each of the data line write period and/or the pixel circuit write period may extend such that the data line write and the pixel circuit write are performed during a sufficient time. Accordingly, the display device 250 may reduce the possibility of the lack of data line write or the lack of time for compensating a threshold value of the driving transistor M1, and thus, may reduce image quality deterioration due to the lack of data line write or the lack of time for compensating a threshold value of the driving transistor M1.

In addition, in relation to the display device 250, a data line (e.g., DTk(x)) is supplied with data when a corresponding switch of the second switching unit 256 is tuned on based on the selection signal SEL and a corresponding data selection switch of the first switching unit 254 is turned on based on the switching control signal CL. For example, as shown in FIGS. 9 and 10, the order of writing data to a pixel circuit during horizontal period varies for pixel circuits adjacent in a column (or row) of a plurality of pixel circuits. For example, the order of writing data to a first pixel circuit during one horizontal period (e.g., a horizontal period of each the data line write period and the pixel circuit write period) is different from the order of writing data to a second pixel circuit adjacent in a column (or row) of a plurality of pixel circuits.

Accordingly, in the display device 250, since a single horizontal period includes a plurality of data write timings in the first horizontal period, the influence of data line variation may be reduced, and thus, image quality deterioration (e.g., line defects) due to the data line variation may be reduced.

A configuration of a display device according to an exemplary embodiment of the present inventive concept is not limited to the configuration of the display device 200 of FIG. 7 or the display device 250 of FIG. 9.

In an exemplary embodiment of the present inventive concept, the driver 208 shown in FIG. 7 or the driver 258 shown in FIG. 9 may be implemented as an external driver of the display device 200 or the display device 250. The display device (e.g., 200 or 250) according to an exemplary embodiment of the present inventive concept may further include a driver that outputs various control signals CLRS.

In the display device (e.g., the display device 200 or the display device 250) according to an exemplary embodiment of the present inventive concept, each group of data lines (e.g., DT1(x) through DTn(x)) of FIG. 7 or DT1(x) and DT2(x) of FIG. 9) included in a plurality of data lines is disposed to correspond to each column (or row) (e.g., an x-th column (or row)) of a plurality of pixel circuits disposed in a matrix, and a data update period includes a data line write period and a pixel circuit write period. In addition, as shown in FIG. 8 or 10, the data update period includes a plurality of horizontal periods. Some of the plurality of horizontal periods corresponds to the data line write period, and horizontal periods excluding the data line write period among the plurality of horizontal periods correspond to the pixel circuit write period. Accordingly, the display device according to an exemplary embodiment of the present inventive concept may extend a data write time.

In addition, in the display device (e.g., the display device 200 or the display device 250) according to an exemplary embodiment of the present inventive concept, data corresponding to a fixed color is supplied to each of the plurality of data lines. For example, a color represented by data supplied to each data line of the group of data lines is fixed (e.g., not changed). Each group of data lines (e.g., DT1(x) through DT3(x) of FIG. 7 or DT1(x) and DT2(x) of FIG. 9) included in the plurality of data lines is disposed to correspond to each column (or row) (e.g., an x-th column (or row)) of a plurality of pixel circuits. Thus, a data line (e.g., DTi(x)) connected to a first pixel circuit is different from a data line (e.g., DTj(x)) connected to a second pixel circuit which is adjacent to the first pixel circuit in a row or column direction.

Accordingly, in the display device (e.g., the display device 200 or the display device 250) according to an exemplary embodiment of the present inventive concept, image quality deterioration such as line defects due to a data line variation is reduced.

As shown in FIGS. 7 to 10, in the display device (e.g., 200 or 250) according to an exemplary embodiment of the present inventive concept, the order of writing data to a pixel circuit during one horizontal period varies for pixel circuits adjacent in a column (or row) of a plurality of circuits.

Accordingly, in the display device (e.g., 200 or 250), since a single horizontal period includes a plurality of data write timings, image quality deterioration (e.g., line defects) due to the data line variation may be reduced.

Accordingly, the display device (e.g., 200 or 250) according to an exemplary embodiment of the present inventive concept may reduce image quality deterioration due to the lack of data write and a data line variation.

In addition, as shown in FIGS. 7 and 9, since a data line (e.g., DTk(x)) and a driver output are connected to each other and operated by turning on or off each of a plurality of switches (e.g., 204 and 206 of FIGS. 7 and 254 and 256 of FIG. 9), the display device (e.g., 200 or 250) according to an exemplary embodiment of the present inventive concept may reduce the number of driver outputs.

A configuration of a display device according to an exemplary embodiment of the present inventive concept is not limited to those of FIGS. 1, 5, 7, and 9. For example, a display device according to an exemplary embodiment of the present inventive concept may be applied to televisions, tablet devices such as a tablet personal computer (PC), communication devices such as mobile phones, smartphones, or the like, image/music playback devices (or image/music recording and playing devices), game consoles, computers such as personal computers (PCs), or the like.

While exemplary embodiments of the present inventive concept have been particularly shown and described, it will be understood that various change in form and detail may be made therein without departing from the spirit and scope of the present inventive concept as defined by the following claims.

What is claimed is:

1. A display device comprising:
a plurality of pixel circuits disposed in a matrix;
a plurality of data lines including a first group of data lines and a second group data lines, wherein each of the first group of data lines is connected to at least one of the pixel circuits in a first column or a first row of the plurality of pixel circuits, and each of the second group of data lines is connected to at least one of the pixel circuits in a second column or a second row of the plurality of pixel circuits; and
a plurality of data selection switches, each of which connects one of the first group of data lines and one of a plurality of driver output ports in response to a switching control signal,
wherein each of the plurality of driver output ports outputs data corresponding to one of colors of light emitted through the plurality of pixel circuits,
wherein the data corresponding to one of the colors of light emitted through the plurality of pixel circuits is supplied to at last one data line of the first group of data lines,
wherein the first group of data lines includes a first data line connected to a first pixel circuit of the plurality of pixel circuits and a second data line connected to a second pixel circuit of the plurality of pixel circuits adjacent to the first pixel circuit, and the first and second data lines are different from each other,
wherein a data update period for updating data written to at least a third pixel circuit of the plurality of pixel circuits comprises a data line write period for writing data to a third data line of the plurality of data lines and a pixel circuit write period for writing data to the third pixel circuit, and
wherein the pixel circuit write period occurs after the data line write period.

2. The display device of claim 1, wherein the data update period comprises a plurality of horizontal periods,
the data line write period corresponds to some of the plurality of horizontal periods, and
the pixel circuit write period corresponds to horizontal periods excluding those corresponding to the data line write period among the plurality of horizontal periods.

3. The display device of claim 2, wherein
a plurality of data writes are performed within a first horizontal period in the data line write period or the pixel circuit write period; and
an order of writing data to a first pixel circuit during the first horizontal period is different from an order of writing data to a second pixel circuit adjacent to the first pixel circuit.

4. The display device of claim 1, wherein a first data selection switch of the plurality of data selection switches connects a first data line and a first driver output port of the plurality of driver output ports in a first horizontal period, and
wherein a second data selection switch of the plurality of data selection switches connects the second data line and a second driver port of the plurality of driver output ports in a second horizontal period different from the first horizontal period.

5. The display device of claim 1, further comprising a driver having the plurality of driver output ports.

6. The display device of claim 1, further comprising a driver outputting the switching control signal.

7. The display device of claim 1, wherein each of the first group of data lines is disposed in a region adjacent to the first column or the first row of the plurality of pixel circuits.

8. The display device of claim 7, wherein the first data line is disposed in a first side of the first column or the first row,
wherein the second data line is disposed in a second side of the first column or the first row, and
wherein the second side is an opposite side to the first side.

9. A driving method of a display device, comprising:
updating data written to each pixel circuit of a plurality of pixel circuits,
wherein updating the data comprises:
writing first data of the data to a first data line of a plurality of data lines in the display device during a first period; and
writing the first data to a first pixel circuit of the plurality of pixel circuits during a second period subsequent to the first period,
wherein the display device comprises,
the plurality of pixel circuits;
the plurality of data lines including a first group of data lines and a second group data lines, wherein each of the first group of data lines is connected to at least one of the pixel circuits in a first column or a first row of the plurality of pixel circuits, and each of the second group of data lines is connected to at least one of the pixel circuits in a second column or a second row of the plurality of pixel circuits; and
a plurality of data selection switches, each of which connects one of the first group of data lines and one of a plurality of driver output ports in response to at least one of the plurality of switching control signals,
wherein each of the plurality of driver output ports outputs the data corresponding to one of colors of light emitted through the plurality of pixel circuits,
wherein the data corresponding to one of the colors of light emitted through the plurality of pixel circuits is supplied to each data line of the first group of data lines, and
wherein the first group of data lines includes the first data line connected to the first pixel circuit and a second data line connected to a second pixel circuit of the plurality of pixel circuits adjacent to the first pixel circuit.

10. The driving method of claim 9, further comprising:
writing second data of the data to the second data line during the second period; and
writing the second data to the second pixel circuit during a third period subsequent to the second period.

11. A display device comprising:
a plurality of pixel circuits;
a plurality of data lines including a first group of data lines and a second group data lines, wherein each of the first group of data lines is connected to at least one of the pixel circuits in a first column or a first row of the plurality of pixel circuits, and each of the second group of data lines is connected to at least one of the pixel circuits in a second column or a second row of the plurality of pixel circuits; and
a plurality of switches, each of which controls a connection between one of the first group of data lines and one of a plurality of driver output ports in response to a switching control signal,
wherein each of the plurality of driver output ports outputs the switching control signal and first data to at least one data line of the first group of data lines through at least one of the plurality of switches,
wherein the first group of data lines includes a first data line connected to a first pixel circuit of the plurality of pixel circuits and a second data line connected to a second pixel circuit of the plurality of pixel circuits adjacent to the first pixel circuit.

12. The display device of claim 11, wherein the first data corresponds to one of colors of light emitted through the plurality of pixel circuits.

13. The display device of claim 12, wherein the colors of light emitted through the plurality of pixel circuits includes a red color, a green color, or a blue color.

14. The display device of claim 12, wherein a data update period for updating data written to at least a third pixel circuit of the plurality of pixel circuits comprises a data line write period for writing data to a third data line of the plurality of data lines and a pixel circuit write period for writing data to the third pixel circuit, and
wherein the pixel circuit write period is subsequent to the data line write period.

15. The display device of claim 14, wherein the data update period comprises a plurality of horizontal periods,
wherein the data line write period corresponds to some of the plurality of horizontal periods, and
wherein the pixel circuit write period corresponds to horizontal periods excluding those corresponding to the data line write period among the plurality of horizontal periods.
